(19) United States
(12) Patent Application Publication
(10) Pub. No.: US 2023/0407490 A1
(43) Pub. Date: Dec. 21, 2023

(54) A WATER ELECTROLYZER SYSTEM

(71) Applicant: NATIONAL UNIVERSITY OF SINGAPORE, Singapore (SG)

(72) Inventors: Qing Wang, Beijing (CN); Feifei Zhang, Beijing (CN)

(73) Assignee: National University of Singapore, Singapore (SG)

(21) Appl. No.: 18/251,770

(22) PCT Filed: Nov. 3, 2021
(86) PCT No.: PCT/SG2021/050667

§ 371 Date: May 4, 2023

(30) Foreign Application Priority Data
Nov. 4, 2020 (SG) 10202010967R

(51) Int. Cl. C25B 1/04; C25B 9/19; C25B 15/031

(52) U.S. Cl. CPC C25B 1/04; C25B 9/19; C25B 15/031

(57) ABSTRACT

Disclosed herein is a spatially decoupled redox flow water electrolyzer, that has a hydrogen-producing catholyte section formed from a catholyte tank, having a cathode, and a hydrogen generation compartment, where the catholyte tank and the hydrogen generation compartment are fluidly connected to one another by a fluid pathway, so as to facilitate the circulation of a liquid catholyte from the catholyte tank to the hydrogen generation compartment and back to the catholyte tank and an oxygen-producing anolyte section formed from an anolyte tank, having an anode, and an oxygen producing compartment, where the anolyte tank and the oxygen producing compartment are fluidly connected to one another by a fluid pathway, so as to facilitate the circulation of a liquid anolyte from the anolyte tank to the oxygen producing compartment and back to the anolyte tank, an anion-exchange membrane is disposed between the catholyte and anolyte tanks and a current collector attached to the catholyte and anolyte tanks. In use, the hydrogen generation compartment contains a catalyst capable of catalysing hydrogen production when brought into contact with a cathodic redox mediator when the cathodic redox mediator is in a reduced state and the oxygen generation compartment contains a catalyst capable of catalysing oxygen production when brought into contact with an anodic redox mediator when the anodic redox mediator is in an oxidised state.

### FIELD OF INVENTION

The current invention relates to a water electrolyzer system capable of generating hydrogen and oxygen gas simultaneously, but separately, as well as the operation of the system.

### BACKGROUND

The listing or discussion of a prior-published document in this specification should not necessarily be taken as an acknowledgement that the document is part of the state of the art or is common general knowledge.

With rising concerns for energy and environment, there has been an increasing demand for clean and renewable energy sources to replace fossil fuels. Hydrogen is an energy carrier and an important feedstock for the chemical industry, and is considered one of the most important clean fuels. However, a vast majority of hydrogen in the world is obtained by natural gas steam re-forming, which produces CO₂ with an inevitable carbon footprint. Electrolytic water splitting by generating hydrogen and oxygen from water without additional emissions has attracted considerable attention due to its inherent advantages of producing relatively pure hydrogen, flexibility for small and large-scale production, and sustainability when the electricity used in the electrolysis comes from renewable sources (Lu, X. & Zhao, C., Nat. Commun. 2015, 6, 6616; Wang, Y. et al., Nano Energy 2018, 48, 590-599; and Wang, X. P. et al., Energy Environ. Sci. 2020, 13, 229-237).

In a conventional water splitting system where hydrogen and oxygen evolution occur simultaneously at the two electrodes separated by a diaphragm or ion-exchange membrane, gas crossover issue can happen, especially at low operating current density or elevated pressures, rendering the need for further purification of the collected hydrogen gas. In addition, the formed OH· radicals deteriorate the membrane and other cell components.

To mitigate the above issues, some novel systems have recently been devised to decouple the formation of H₂ and O₂. One effective way is to use a third redox system, such as nickel hydroxide (Chen, L. et al., Nat. Commun. 2016, 7, 11741) or anthraquinone-2,7-disulfonic acid (Kirkaldy, N. et al., Chem. Sci. 2018, 9, 1621-1626), the redox potential of which is between the hydrogen evolution reaction (HER) and oxygen evolution reaction (OER) potential, so as to divide the water electrolysis into two chronologically separated steps for H₂ and O₂ production at different times. Another way is to employ an electron-coupled proton buffer which has a high proton-electron storage capacity, with which H₂ can be produced at a separate time on demand (Rausch, B. et al., Science 2014, 345, 1326-1330; Chen, J. J.; Symes, M. D. & Cronin, L., Nat. Chem. 2018, 10, 1042-1047; MacDonald, L. et al., Sustain. Energy Fuels 2017, 1, 1782-1787; and Lei, J. et al., Chemistry 2019, 25, 11432-11436). Nevertheless, despite improved separation of high purity gases, H₂ and O₂ cannot be produced concurrently, which inevitably results in an extended time because of the intermittent operation. In addition, the formation of H₂ and/or O₂ mostly remains at the electrode/electrolyte interface, which results in an inflated overpotential due to the adsorption of the produced gaseous species on the electrodes (Angulo, A. et al., Joule 2020, 4, 555-579). The bubbles evolved on the electrode may induce blockage of the electrocatalyst surface and decrease the ion conductivity in the electrolyte (Wu, H. et al., J. Mater. Chem. A 2017, 5, 24153-24158; and Belleville, P. et al., Int. J. Hydrog. Energy 2018, 43, 14867-14875). In an alternative approach, Girault and coworkers incorporated a redox-flow battery module, using V²⁺/³⁺ and Ce³⁺/⁴⁺ as the redox mediators in strong acid media for both energy storage and task specific H₂ production (Peljo, P. et al., Green Chem. 2016, 18, 1785-1797; Dennison, C. R. et al., Chimia (Aarau) 2015, 69, 753-758; and Amstutz, V. et al., Energy Environ. Sci. 2014, 7, 2350-2358). While it allows for concurrent off-electrode H₂/O₂ generation, it is limited by the inherently large free energy loss and the use of corrosive electrolytes.

Therefore, there is a need to develop new water electrolyzers that can overcome the limitations of existing water electrolyzers.

### SUMMARY OF INVENTION

It has been surprisingly found that it is possible to generate hydrogen and oxygen gas simultaneously, continuously and separately from a water electrolyzer system.

Aspects and embodiments of the invention are now discussed by reference to the following numbered clauses.

1. A spatially decoupled redox flow water electrolyzer, comprising:
a hydrogen-producing catholyte section comprising a catholyte tank, having a cathode, and a hydrogen generation compartment, where the catholyte tank and the hydrogen generation compartment are fluidly connected to one another by a fluid pathway, so as to facilitate the circulation of a liquid catholyte from the catholyte tank to the hydrogen generation compartment and back to the catholyte tank;
an oxygen-producing anolyte section comprising an anolyte tank, having an anode, and an oxygen producing compartment, where the anolyte tank and the oxygen producing compartment are fluidly connected to one another by a fluid pathway, so as to facilitate the circulation of a liquid anolyte from the anolyte tank to the oxygen producing compartment and back to the anolyte tank;
an anion-exchange membrane disposed between the catholyte and anolyte tanks that allows anions to move from the catholyte tank to the anolyte tank; and
a current collector attached to the catholyte and anolyte tanks, wherein:
   the hydrogen generation compartment is configured to house a catalyst capable of catalysing hydrogen production when brought into contact with a cathodic redox mediator when the cathodic redox mediator is in a reduced state; and
   the oxygen generation compartment is configured to house a catalyst capable of catalysing oxygen production when brought into contact with an anodic redox mediator when the anodic redox mediator is in an oxidised state.

2. The electrolyzer according to Clause 1, wherein:
(a) the hydrogen-producing catholyte section further comprises:
   a liquid catholyte that comprises a supporting electrolyte and a cathodic redox mediator capable of producing hydrogen; and
   a catalyst capable of catalysing hydrogen production when brought into contact with a cathodic redox mediator when the cathodic redox mediator is in a reduced state, where the catalyst is housed in the hydrogen generation compartment; and
(b) the oxygen-producing anolyte section further comprises:
   a liquid anolyte that comprises a supporting electrolyte and an anodic redox mediator capable of producing oxygen; and
   a catalyst capable of catalysing oxygen production when brought into contact with an anodic redox mediator when the anodic redox mediator is in an oxidised state, where the catalyst is housed in the oxygen generation compartment.

3. The electrolyzer according to Clause 2, wherein the supporting electrolyte comprises a solvent and one or more compounds or salts that provide ions.

4. The electrolyzer according to Clause 3, wherein the ions in the salts that provide ions are selected from:
hydroxide ions and/or chloride ions; and
one or more of the groups consisting of ammonium ions, lithium ions, sodium ions, potassium ions, magnesium ions, calcium ions, optionally wherein the ions in the salts that provide ions are sodium ions and hydroxide ions.

5. The electrolyzer according to Clause 3 or Clause 4, wherein the solvent is water.

6. The electrolyzer according to any one of Clauses 3 to 5, wherein one or more of the following apply:
(a) the pH of the electrolyte is from 11 to 15;
(b) the concentration of the one or more compounds or salts that provide ions in the solvent is from 0.05 to 10 M, such as from 1 to 5 M, such as about 4 M.

7. The electrolyzer according to any one of Clauses 2 to 6, wherein the cathodic redox mediator is selected from one or more of DHPS/DHPS-2H, iron (III) triethanolamine/iron (II) triethanolamine, phenazine and derivatives thereof, and viologen and derivatives thereof, optionally wherein the cathodic redox mediator is DHPS/DHPS-2H.

8. The electrolyzer according to any one of Clauses 2 to 7, wherein the cathodic redox mediator is provided in the liquid catholyte at a total concentration of the redox mediator(s) from 0.05 to 3 M, such as from 0.2 to 2 M, such as from 0.5 to 1 M or from 0.4 to 0.8 M, such as about 0.6 M.

9. The electrolyzer according to any one of Clauses 2 to 8, wherein the anodic redox mediator is selected from one or more of [Fe(CN)₆]³⁻/[Fe(CN₆)]⁴⁻, [MnO₄]²⁻/[MnO₄]⁻, ferrocene and derivatives thereof, and TEMPO and derivatives thereof, optionally wherein the anodic redox mediator is [Fe(CN)₆]³⁻/[Fe(CN₆)]⁴⁻.

10. The electrolyzer according to any one of Clauses 2 to 9, wherein the anodic redox mediator is provided in the liquid anolyte at a total concentration of the redox mediator(s) from 0.05 to 3 M, such as from 0.2 to 2 M, such as from 0.5 to 1 M or from 0.4 to 0.8 M, such as about 0.6 M.

11. The electrolyzer according to any one of Clauses 2 to 10, wherein the catalyst in the oxygen generation compartment is selected from one or more of the group consisting of NiFe(OH)₂@Ni, IrO₂, RuO₂, other transition metal oxides (TMOs), carbides (TMCs), nitrides (TMNs), phosphides (TMPs), dichalcogenides (TMDs), and borides (TMBs), optionally wherein the catalyst is NiFe(OH)₂@Ni.

12. The electrolyzer according to any one of Clauses 2 to 11, wherein the catalyst in the hydrogen generation compartment is selected from one or more of the group consisting of Pt—Ni(OH)₂@Ni, Pt@C, a transition metal (TM), a metal alloy, a transition metal oxide (TMO), a transition metal carbide (TMCs), a transition metal nitride (TMNs), a transition metal phosphide (TMPs), a transition metal dichalcogenide (TMD), a transition metal boride (TMBs), and a noble metal, optionally wherein the catalyst is Pt—Ni(OH)₂@Ni.

13. The electrolyzer according to any one of Clauses 2 to 12, wherein the electrolyzer is configured to introduce the liquid catholyte and/or the liquid catholyte to the hydrogen generation compartment and oxygen generation compartment, respectively, as a spray.

14. The electrolyzer according to any one of Clauses 2 to 13, wherein the electrolyzer is able to generate oxygen and/or hydrogen with a purity of greater than or equal to 99.9%, such as 99.99%.

15. The electrolyzer according to any one of Clauses 2 to 13, wherein the weight ratio of the catalyst in the oxygen generation compartment to the catalyst in the hydrogen generation compartment is from 0.1:1 to 10:1, such as from 0.5:1 to 2:1.

16. A method of using a spatially decoupled redox flow water electrolyzer according to Clause 1, involving the steps of:
(a) supplying:
   (i) a liquid catholyte that comprises a supporting electrolyte and a cathodic redox mediator capable of producing hydrogen; and a catalyst capable of catalysing hydrogen production when brought into contact with a cathodic redox mediator when the cathodic redox mediator is in a reduced state, where the catalyst is housed in the hydrogen generation compartment; and
   (ii) a liquid anolyte that comprises a supporting electrolyte and an anodic redox mediator capable of producing oxygen; and a catalyst capable of catalysing oxygen production when brought into contact with an anodic redox mediator when the anodic redox mediator is in an oxidised state, where the catalyst is housed in the oxygen generation compartment; and
(b) attaching the anode and cathode to of the anolyte and catholyte tanks, respectively, to a power supply and operating the electrolyzer for a period of time to continually produce oxygen in the oxygen producing compartment and hydrogen in the hydrogen generation compartment.

17. The method according to Clause 16, wherein the supporting electrolyte comprises a solvent and one or more compounds or salts that provide ions.

18. The method according to Clause 17, wherein the ions in the salts that provide ions are selected from:
hydroxide ions and/or chloride ions; and
one or more of the groups consisting of ammonium ions, lithium ions, sodium ions, potassium ions, and magnesium ions, calcium ions, optionally wherein the ions in the salts that provide ions are sodium ions and hydroxide ions.

19. The method according to Clause 17 or Clause 18, wherein the solvent is water.

20. The method according to any one of Clauses 16 to 20, wherein one or more of the following apply:
(a) the pH of the electrolyte is from 11 to 15;
(b) the concentration of the one or more compounds or salts that provide ions in the solvent is from 0.05 to 10 M, such as from 1 to 5 M, such as about 4 M.

21. The method according to any one of Clauses 16 to 20, wherein the cathodic redox mediator is selected from one or more of DHPS/DHPS-2H, iron (III) triethanolamine/iron (II) triethanolamine, phenazine and derivatives thereof, and viologen and derivatives thereof, optionally wherein the cathodic redox mediator is DHPS/DHPS-2H.

22. The method according to any one of Clauses 16 to 21, wherein the cathodic redox mediator is provided in the liquid catholyte at a total concentration of the redox mediator(s) from 0.05 to 3 M, such as from 0.2 to 2 M, such as from 0.5 to 1 M or from 0.4 to 0.8 M, such as about 0.6 M.

23. The method according to any one of Clauses 16 to 22, wherein the anodic redox mediator is selected from one or more of [Fe(CN)₆]³⁻/[Fe(CN₆)]⁴⁻, [MnO₄]₂₋/[MnO₄]⁻, ferrocene and derivatives thereof, and TEMPO and derivatives thereof, optionally wherein the anode redox mediator is [Fe(CN)₆]³⁻/[Fe(CN₆)]⁴⁻.

24. The method according to any one of Clauses 16 to 23, wherein the anodic redox mediator is provided in the liquid anolyte at a total concentration of the redox mediator(s) from 0.05 to 3 M, such as from 0.2 to 2 M, such as from 0.5 to 1 M or from 0.4 to 0.8 M, such as about 0.6 M.

25. The method according to any one of Clauses 16 to 24, wherein the catalyst in the oxygen generation compartment is selected from one or more of the group consisting of NiFe(OH)₂@Ni, IrO₂, RuO₂, other transition metal oxides (TMOs), carbides (TMCs), nitrides (TMNs), phosphides (TMPs), dichalcogenides (TMDs), and borides (TMBs), optionally wherein the catalyst is NiFe(OH)₂@Ni.

26. The method according to any one of Clauses 16 to 25, wherein the catalyst in the hydrogen generation compartment is selected from one or more of the group consisting of Pt—Ni(OH)₂@Ni, Pt@C, a transition metal (TM), a metal alloy, a transition metal oxide (TMO), a transition metal carbide (TMCs), a transition metal nitride (TMNs), a transition metal phosphide (TMPs), a transition metal dichalcogenide (TMD), a transition metal boride (TMBs), and a noble metal, optionally wherein the catalyst is Pt—Ni(OH)₂@Ni.

27. The method according to any one of Clauses 16 to 26, wherein the liquid catholyte and/or the liquid catholyte is introduced to the hydrogen generation compartment and oxygen generation compartment, respectively, as a spray.

28. The method according to any one of Clauses 16 to 27, wherein the electrolyzer is able to generate oxygen and/or hydrogen with a purity of greater than or equal to 99.9%, such as 99.99%.

29. The method according to any one of Clauses 16 to 28, wherein the weight ratio of the catalyst in the oxygen generation compartment to the catalyst in the hydrogen generation compartment is from 0.1:1 to 10:1, such as from 0.5:1 to 2:1.

30. The method according to any one of Clauses 16 to 29, wherein the electrolyzer provides a stable voltage at any given current density.

### DRAWINGS

FIG. 1 depicts an illustration of the spatially decoupled O₂ and H₂ production. (a) Schematic illustration of the operation of a redox-flow electrolytic cell for spatially decoupled O₂ and H₂ production. In practice, the produced O₂ could just be released to surroundings while H₂ is collected from the hydrogen production reactor; and (b) Energy diagram of electrolyte-borne redox-assisted HER and OER reactions with 7,8-dihydroxy-2-phenazinesulfonic acid (DHPS) and ferricyanide as the mediators, respectively. A regenerative electrochemical-chemical cycle is applied on the anodic and cathodic compartments for continuous and concurrent O₂ and H₂ production, respectively.

FIG. 2 depicts peak current vs. the square root of scan rate for (a) 5 mM K₃[Fe(CN)₆]/K₄[Fe(CN)₆] and (b) 5 mM DHPS in 4 M NaOH solution at different scan rates; and (c) Cyclic voltammetry (CV) curves of 5 mM DHPS in 4 M NaOH solution at 0.1 V/s for 500 cycles. It remained nearly unchanged after 500 consecutive cycles in the alkaline solution, indicating the excellent electrochemical stability of DHPS.

FIG. 3 depicts scanning electron microscopy (SEM) images of the Ni(OH)₂ substrate on Ni foam.

FIG. 4 depicts (a, b) SEM and (c) TEM images of Pt—Ni(OH)₂@Ni foam.

FIG. 5 depicts energy X-ray dispersive spectroscopy (EDX) mapping and spectrum of Pt—Ni(OH)₂.

FIG. 6 depicts (a, b) SEM images and (c, d) X-ray photoelectron spectroscopy (XPS) spectra of NiFe(OH)₂@Ni foam.

FIG. 7 depicts the electrochemical-chemical characterizations between the mediator and catalyst. (a) CV curves of 5 mM DHPS and [Fe(CN)₆]^{3-/4-} in 4 M NaOH solution at different scan rates on a glassy carbon electrode; and (b) Linear scan voltammetry (LSV) curves of the two catalyst electrodes in 4 M NaOH solution and LSV curves of 1 M DHPS/NaOH and 0.6 M K₄Fe(CN)₆/NaOH performed on a glassy carbon rotating disc electrode at a rotation speed of 1600 rpm, respectively. The scan rate was 10 mV/s.

FIG. 8 depicts LSV curves of (a) Ni(OH)₂, Pt/C and Pt—Ni(OH)₂; and (b) NiFe(OH)₂ in 4 M NaOH solution. The scan rate was 1 mV/s. The counter electrode was carbon rod and the reference electrode was Hg/HgO electrode. The Pt/C-coated carbon cloth (Pt/C—CC) electrode was prepared by coating commercial 10% Pt/C powder on CC, and the binder was 5% Nafion solution.

FIG. 9 depicts the characterization of the spatially water splitting system. (a) Voltage profile and faradic efficiency of an electrolytic flow cell at different current densities; (b) Gas chromatography (GC) curves of the gas samples collected from the electrolytic flow cell and a conventional electrocatalytic cell; (c) Voltage profile of the flow cell upon continuous H₂ production for 82 h at 20 mA/cm². The inset is a photo of the setup, including an electrolytic flow cell, two reactor tanks and two gas collectors; and ultraviolet-visible (UV-vis) spectra of (d) DHPS in catholyte and (e) [Fe(CN)₆]³⁻ in anolyte, recorded at different durations of charging of the flow cell without and with the addition of the respective catalyst in the reactor tank. The current density was 10 mA/cm².

FIG. 10 depicts galvanostatic intermittent titration technique (GITT) curve of an electrolytic flow cell without catalyst during the charging process.

FIG. 11 depicts the voltage profile of an electrolytic flow cell during a continuous operation for 42 h at 10 mA/cm², and the cumulative production of H₂ and O₂ in the packed-bed catalytic reactor.

FIG. 12 depicts (a) voltage profile of direct water splitting with an electrolytic cell using the same HER/OER catalysts at different current densities. The current density was varied from 20 to 100 mA/cm², and the electrode area was 5 cm²; and comparison of (b) overall energy efficiency and (c) H₂ yield and collection rate, between decoupled and direct water splitting.

FIG. 13 depicts (a) electrochemical impedance spectroscopic analysis of H-cell with and without membrane. The electrolyte was 4 M NaOH solution. All the experiments were conducted on an electrochemical station (Autolab PGSTAT30) with a frequency range of 0.1 to 106 Hz; and (b) plot of ln(C_{A}/(C_{A}−C_{B})) vs. time when using Sustainion® X37-5 membrane. C_{A} is the concentration of DHPS in concentrated side (mol/L) and C_{B} is the concentration of DHPS in deficiency side (mol/L). The enrichment cell was filled with 25 mL of 0.1 M DHPS/4 M NaOH, and the deficiency cell was filled with 30 mL of 4 M NaOH solution. The area of the membrane between the two cell compartments was 2 cm².

FIG. 14 depicts the configuration of the spectroelectrochemical setup for operando UV-vis spectroscopic measurements of (a) catholyte; and (b) anolyte.

FIG. 15 depicts the absorbance changes of (a) DHPS at 560 nm; and (b) [Fe(CN)₆]³⁻ at 470 nm in the respective electrolytes upon charging a cell with/without catalyst. The charging current was 10 mA/cm². Note that as the color of DHPS was very dark, a low concentration of catholyte (0.2 M) was used here. For unknown reason, reproducibly, the absorbance of DHPS dropped quickly in the beginning of test. Nevertheless, the difference in absorbance changes induced by the catalytic HER reaction is obvious.

### DESCRIPTION

It has been surprisingly found that it is possible to generate hydrogen and oxygen gas simultaneously, continuously and separately from a water electrolyzer system. Thus, according to a first aspect of the invention, there is provided a spatially decoupled redox flow water electrolyzer, comprising:
a hydrogen-producing catholyte section comprising a catholyte tank, having a cathode, and a hydrogen generation compartment, where the catholyte tank and the hydrogen generation compartment are fluidly connected to one another by a fluid pathway, so as to facilitate the circulation of a liquid catholyte from the catholyte tank to the hydrogen generation compartment and back to the catholyte tank;
an oxygen-producing anolyte section comprising an anolyte tank, having an anode, and an oxygen producing compartment, where the anolyte tank and the oxygen producing compartment are fluidly connected to one another by a fluid pathway, so as to facilitate the circulation of a liquid anolyte from the anolyte tank to the oxygen producing compartment and back to the anolyte tank;
an anion-exchange membrane disposed between the catholyte and anolyte tanks that allows anions to move from the catholyte tank to the anolyte tank; and
a current collector attached to the catholyte and anolyte tanks, wherein:
   the hydrogen generation compartment is configured to house a catalyst capable of catalysing hydrogen production when brought into contact with a cathodic redox mediator when the cathodic redox mediator is in a reduced state; and
   the oxygen generation compartment is configured to house a catalyst capable of catalysing oxygen production when brought into contact with an anodic redox mediator when the anodic redox mediator is in an oxidised state.

The system described herein uses an electrolytic flow cell integrated with separate gas production reactors. This spatial separation of the generation of H₂ and O₂ allows one to obtain H₂ and O₂ with ultrahigh purity. The H₂ and O₂ can be generated concurrently and continuously in the systems described herein, which results in improved productivity as no time is wasted in having to generate each gas at a separate time. H₂ and O₂ bubbles are completely removed from the flowing electrolyte, which eases cell stack design, as the H₂ and O₂ are produced in separate compartments away from the electrode surfaces, thereby avoiding the blocked surface area and overpotential caused by gas bubbles generated on the electrodes of conventional systems. It is also possible to use low-cost and robust redox active mediators in an alkaline electrolyte (e.g. DHPS/DHPS-2H and [Fe(CN)₆]³⁻/[Fe(CN)₆]⁴⁻). This is less corrosive than directly electrochemical water splitting on the electrode in acidic media, as is conventionally done. Given these advantages, the systems disclosed herein are likely to be more stable than conventional systems, meaning that the costs associated with maintenance will be much less as well.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As will be appreciated, the system described above requires consumables and catalysts to operate. As such, the electrolyzer, where prepared for (and in) use will be one in which:
(a) the hydrogen-producing catholyte section further comprises:
   a liquid catholyte that comprises a supporting electrolyte and a cathodic redox mediator capable of producing hydrogen; and
   a catalyst capable of catalysing hydrogen production when brought into contact with a cathodic redox mediator when the cathodic redox mediator is in a reduced state, where the catalyst is housed in the hydrogen generation compartment; and
   (b) the oxygen-producing anolyte section further comprises:
a liquid anolyte that comprises a supporting electrolyte and an anodic redox mediator capable of producing oxygen; and
   a catalyst capable of catalysing oxygen production when brought into contact with an anodic redox mediator when the anodic redox mediator is in an oxidised state, where the catalyst is housed in the oxygen generation compartment.

Both the cathode and anode compartments contain electrodes, i.e., the cathode and the anode, which can be a carbon, a metal, or a combination thereof. Preferably, these two electrodes have high surface area, to facilitate the desired electrolysis process. They can be made of a carbon, a metal, or a combination thereof.

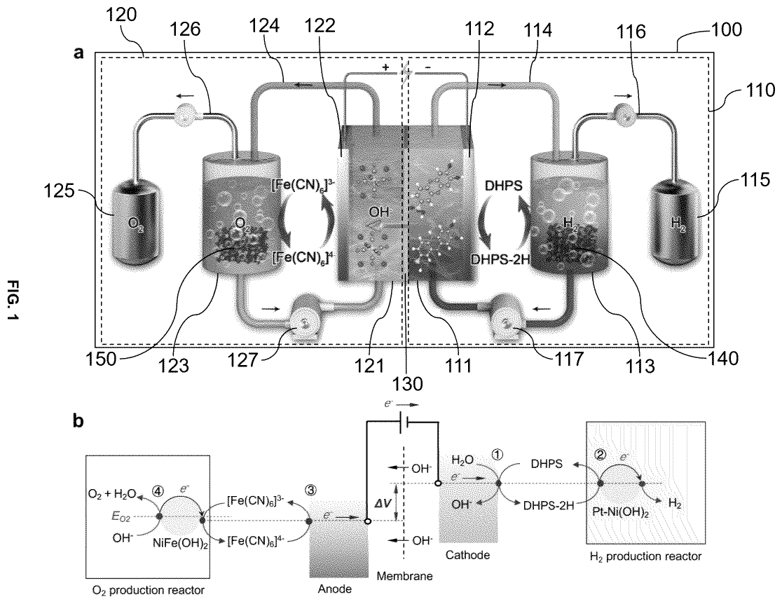

A spatially decoupled redox flow water electrolyzer according to the current invention is depicted in FIG. 1A. As shown, there is a water electrolyzer system 100 that includes a hydrogen-producing catholyte section 110 comprising a catholyte tank 111, having a cathode 112, and a hydrogen generation compartment 113, where the catholyte tank and the hydrogen generation compartment are fluidly connected to one another by a fluid pathway 114, so as to facilitate the circulation of a liquid catholyte (not shown) from the catholyte tank to the hydrogen generation compartment and back to the catholyte tank. The hydrogen-producing catholyte section 110 may also include a hydrogen gas storage tank 115 that is connected by a suitable fluid pathway 116 to the hydrogen generation compartment 113. The water electrolyzer system 100 also includes an oxygen-producing anolyte section 120 comprising an anolyte tank 121, having an anode 122, and an oxygen producing compartment 123, where the anolyte tank and the oxygen producing compartment are fluidly connected to one another by a fluid pathway 124, so as to facilitate the circulation of a liquid anolyte (not shown) from the anolyte tank to the oxygen producing compartment and back to the anolyte tank. The oxygen-producing anolyte section 120 may also include an oxygen gas storage tank 125 that is connected by a suitable fluid pathway 126 to the oxygen generation compartment 123. As will be appreciated, in use, the catholyte and anolyte may be circulated through the fluid pathways by any suitable means, such as by use of a suitable pumping system (e.g. pumps 117 and 127).

An anion-exchange membrane 130 is disposed between the catholyte 111 and anolyte 121 tanks, which allows anions to move from the cathode tank to the anode tank. A current collector is also attached to the catholyte and anolyte tank.

As depicted in FIG. 1A, the hydrogen generation compartment is configured to house a catalyst 140 capable of catalysing hydrogen production when brought into contact with a cathodic redox mediator when the cathodic redox mediator is in a reduced state, and the oxygen generation compartment is configured to house a catalyst 150 capable of catalysing oxygen production when brought into contact with an anodic redox mediator when the anodic redox mediator is in an oxidised state. As will be appreciated, when prepared and ready for operation (or when in use), the device will be loaded with the required catalysts 140, 150 in the respective generation compartments, as well as a liquid catholyte and a liquid anolyte in the respective sections.

Both the liquid catholyte and the liquid anolyte require the presence of a supporting electrolyte and the desired redox mediator. The supporting electrolyte referred to above in connection to the liquid catholyte and liquid anolyte may comprise a solvent and one or more compounds or salts that provide ions.

A suitable solvent for use in the supporting electrolyte is water.

As mentioned above, the supporting electrolyte also comprises one or more compounds or salts that provide ions. Any suitable material may be used in this capacity. Suitable ions that may be mentioned herein include, but are not limited to ammonium ions, lithium ions, sodium ions, potassium ions, magnesium ions, calcium ions, chloride ions, and hydroxide ions (e.g. ammonium ions, lithium ions, sodium ions, potassium ions, chloride ions, and hydroxide ions). For example, sodium hydroxide may be used as a source of sodium and hydroxide ions.

The supporting electrolyte may be a material that is basic in nature. For example, the supporting electrolyte may have a pH value of from 11 to 15. The concentration of the one or more compounds or salts that provide ions in the solvent may be from 0.05 to 10 M, such as from 1 to 5 M, such as about 4 M.

A redox mediator refers to a compound present (e.g., dissolved) in the electrolyte (catholyte or anolyte) that acts as a molecular shuttle transporting charges between the respective electrodes and the catalysts. A redox mediator transports charge between the respective electrode and the catalyst.

The cathodic redox mediator is selected from one or more of DHPS/DHPS-2H, iron (III) triethanolamine/iron (II) triethanolamine, phenazine and derivatives thereof, and viologen and derivatives thereof. For example, the cathodic redox mediator may be DHPS/DHPS-2H.

Viologens are 1,1′-disubstituted 4,4′-bipyridinium ions (where the nitrogen atoms of the pyridine rings are substituted by an alkyl group (e.g. C₁ to C₁₂ alkyl)), with a suitable counterion (e.g. Cl⁻, F⁻, Br and I⁻). An example of a viologen of this type is paraquat. When used herein viologens may include related compounds, such as diquat and bipolaron. Thus, the term “viologens and derivatives thereof” should be interpreted accordingly.

Phenazine and derivatives thereof may refer to phenazine itself, as well as phenothiazine derivatives and phenoxazine derivatives, which may be used as redox mediators and may have the following structure:

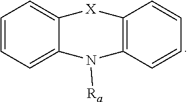

Rₐ can be H or C₁₋₂₀ alkyl, X can be N, O or S, each of the aromatic moieties is optionally substituted with one or more of the following groups: F, Cl, Br, I, NO₂, COOR, R, CF₃, and COR, in which R can be H or C₁₋₂₀ alkyl.

The cathodic redox mediator may be provided in the liquid catholyte at a total concentration of the redox mediator(s) from 0.05 to 3 M, such as from 0.2 to 2 M, such as from 0.5 to 1 M or from 0.4 to 0.8 M, such as about 0.6 M.

The anodic redox mediator may be selected from one or more of [Fe(CN)₆]³⁻/[Fe(CN₆)]⁴⁻, [MnO₄]²⁻/[MnO₄]⁻, ferrocene and derivatives thereof, and TEMPO and derivatives thereof. For example, the anodic redox mediator may be [Fe(CN)₆]³⁻/[Fe(CN₆)]⁴⁻.

Derivatives of ferrocene that may be mentioned herein include ferrocene derivatives having the structure:

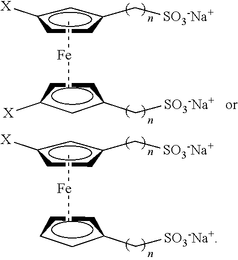

In the above formulae, X is selected from H, F, Cl, Br, I, NO₂, COOR, C₁₋₂₀ alkyl, CF₃, and COR, in which R is H or C₁₋₂₀ alkyl; n is from 0 to 20.

Specific derivatives of ferrocene that may be mentioned herein include but are not limited to bromoferrocene, ferrocenylmethyl dimethyl ethyl ammonium bis(trifluoromethanesulfonyl)imide (Fc1N112-TFSl), N-(pyridin-2-ylmethylene)-1-(2-(diphenylphosphino) ferrocenyl) ethanamine (FeCp₂PPh₂RCN), 1,1-dimethylferrocene (DMFc), tetraferrocene, di(ethylsulfonic sodium) ferrocene (C₁₄H₁₆FeS₂O₆Na₂), and di(trimethanesulfonic sodium) ferrocene (C₁₆H₂₂FeS₂O₆Na₂).

In particular embodiments of the invention that may be mentioned herein, the derivative of ferrocene may be di(trimethanesulfonic sodium) ferrocene (C₁₆H₂₂FeS₂O₆Na₂) or di(ethylsulfonic sodium) ferrocene (C₁₄H₁₆FeS₂O₆Na₂).

TEMPO is 2,2,6,6-tetramethylpiperidin-1-yl)oxyl and derivatives thereof that may be mentioned herein include, but are not limited to 4-Hydroxy-TEMPO, 4-oxo-TEMPO, 4-amino-TEMPO, 4-cyano-TEMPO and 4-carboxy-TEMPO.

The anodic redox mediator is provided in the liquid anolyte at a total concentration of the redox mediator(s) from 0.05 to 3 M, such as from 0.2 to 2 M, such as from 0.5 to 1 M or from 0.4 to 0.8 M, such as about 0.6 M.

The catalyst used in the oxygen generation compartment may be selected from one or more of the group consisting of NiFe(OH)₂@Ni, IrO₂, RuO₂, other transition metal oxides (TMOs), carbides (TMCs), nitrides (TMNs), phosphides (TMPs), dichalcogenides (TMDs), and borides (TMBs). For example, the catalyst may be NiFe(OH)₂@Ni.

The catalyst in the hydrogen generation compartment may be selected from one or more of the group consisting of Pt—Ni(OH)₂@Ni, Pt@C, a transition metal (TM), a metal alloy, a transition metal oxide (TMO), a transition metal carbide (TMCs), a transition metal nitride (TMNs), a transition metal phosphide (TMPs), a transition metal dichalcogenide (TMD), a transition metal boride (TMBs), and a noble metal. For example, the catalyst may be Pt—Ni(OH)₂@Ni.

An advantage of the current system is that it allows for both oxygen and hydrogen gas to be generates at separate locations, thereby avoiding the issues associated with conventional devices. However, as will be appreciated, if one pumps a liquid into a container, then this may cause issues if the result of this input involves the generation of a gas. To avoid this, the electrolyte could be introduced into the respective gas generation compartments in the form of a spray to avoid flooding of the catalyst beds and facilitate the removal of the formed gas. Thus, in certain embodiments of the invention, the electrolyzer may be configured to introduce the liquid catholyte and/or the liquid catholyte to the hydrogen generation compartment and oxygen generation compartment, respectively, as a spray.

As noted above, an advantage of the current system is the ability to generate oxygen and hydrogen gas simultaneously at different locations within the system. This may help to produce hydrogen and oxygen gas of very high purity. For example, the electrolyzer of the current invention may be able to generate oxygen and/or hydrogen with a purity of greater than or equal to 99.9%, such as 99.99%.

A further advantage of the decoupling of the oxygen and hydrogen production is that could enhance the overall power performance of the device by loading more catalysts (e.g., into the oxygen generation compartment in particular) without otherwise needing to alter the electrochemical cell. In embodiments of the invention, the weight ratio of the catalyst in the oxygen generation compartment to the catalyst in the hydrogen generation compartment may be from 0.1:1 to 10:1, such as from 0.5:1 to 2:1.

In a second aspect of the invention, there is provided a method of using a spatially decoupled redox flow water electrolyzer as described hereinbefore, involving the steps of:
(a) supplying:
   (i) a liquid catholyte that comprises a supporting electrolyte and a cathodic redox mediator capable of producing hydrogen; and a catalyst capable of catalysing hydrogen production when brought into contact with a cathodic redox mediator when the cathodic redox mediator is in a reduced state, where the catalyst is housed in the hydrogen generation compartment; and
   (ii) a liquid anolyte that comprises a supporting electrolyte and an anodic redox mediator capable of producing oxygen; and a catalyst capable of catalysing oxygen production when brought into contact with an anodic redox mediator when the anodic redox mediator is in an oxidised state, where the catalyst is housed in the oxygen generation compartment; and
(b) attaching the anode and cathode to of the anolyte and catholyte tanks, respectively, to a power supply and operating the electrolyzer for a period of time to continually produce oxygen in the oxygen producing compartment and hydrogen in the hydrogen generation compartment.

An advantage of the device and method used herein is that the electrolyzer may provide a stable voltage at any given current density.

As details of the materials are discussed extensively above in relation to these devices, they will not be repeated here again in relation to the method for the sake of brevity. Details of how to operate the system may be obtained from the Examples section below.

Further aspects and embodiments of the invention will now be discussed below by reference to the following non-limiting examples.

### EXAMPLES

### Materials

All the chemicals and reagents were purchased from commercial suppliers and used without further purification. Benzene-1,2-daimine, 2,5-dihydroxy-1,4-benzoquinone, K₂PtCl₄, Ni(NO₃)₂·6H₂O, Fe(NO₃)₃·9H₂O, NaOH were purchased from Sigma-Aldrich. HCl and H₂SO₄ were purchased from Alfa Aesar. 10% wt. platinum on carbon was purchased from Fuel Cell Earth. Carbon felt was purchased from Tieling Shenhe Carbon Fiber Material Company. Anion-exchange membrane (Fumasep® FAAM-15) was purchased from Fuel Cell Store. Anion-exchange membrane (Sustainion® X37-50 membrane) was purchased from Dioxide Materials.

### Analytical Techniques

The catalyst was directly used for FESEM, EDX and XPS characterizations without any further preparation.

### Field Emission Scanning Electron Microscope (FESEM)

The morphology and microstructure of the synthesized materials were characterized by a Zeiss Supra 40 FESEM at 5 kV.

### EDX Spectroscopy

EDX was recorded at an acceleration voltage of 15 kV.

### XPS

XPS analysis was conducted with a Kratos Analytical Axis Ultra DLD spectrometer. Monochromated Al K radiation was used as the radiation source, and all the measurements were carried out in vacuum.

### Transmission Electron Microscopy (TEM)

TEM measurement was performed on a JEOL-3010 (300 kV acceleration voltage). The samples were ultrasonically dispersed in ethanol for 1 h and the supernatant was dripped onto a copper grid.

### Nuclear Magnetic Resonance (NMR) Spectroscopy

¹H NMR spectroscopic measurements were performed on Bruker 400 MHz spectrometers. The NMR spectra were recorded in solutions of deuterated dimethyl sulfoxide (DMSO-d₆) with residual DMSO (2.49 ppm for ¹H NMR) taken as the internal standard. Where necessary, NMR spectra were recorded on Bruker 500 MHz spectrometer using aqueous samples with 10% D₂O and suppressed the water signal. The chemical shifts were expressed in parts per million (δ).

### UV-Vis Spectroscopy

UV-vis spectra were collected with a SHIMADZU UV-1800 spectrometer.

### Example 1. Alkaline Redox-Flow Electrolytic Cell Integrated with Separate Gas Production Reactors

We report an alkaline redox-flow electrolytic cell integrated with separate gas production reactors to spatially decouple the concurrently generated H₂ and O₂ (FIG. 1).

A pair of redox mediators were employed as electrolyte-borne charge carriers circulating between the central electrode compartment and separate catalyst bed. Upon operation, the mediators are electrochemically charged on the electrode and then chemically discharged through catalytic HER and OER reactions in the respective reactor tank. For alkaline water electrolysis, despite the advantage of better durability and feasibility for large-scale production (Wang, Y. et al., Nano Energy 2018, 48, 590-599; and Wei, J. et al., Nano-Micro Lett. 2018, 10, 75), a major challenge is that an additional energy barrier stemming from the sluggish water dissociation step needs to be overcome to generate the essential H* intermediates for hydrogen evolution (Mahmood, N. et al., Adv. Sci. 2018, 5, 1700464; Hong, Y., Choi, C. H. & Choi, S. I., ChemSusChem 2019, 12, 4021-4028; Kou, T. et al., Nat. Commun. 2020, 11, 590; and Wang, Y. et al., Adv. Energy Mater. 2017, 7, 1601390). Herein, the phenazine derivative DHPS was employed as the HER redox mediator, which acts as both proton and electron carriers to circumvent the aforementioned rate-limiting step, as DHPS has been reported to be a robust anodic redox mediator for alkaline flow battery (Hollas, A. et al., Nat. Energy 2018, 3, 508-514). As shown in FIG. 1b, the reduction (or hydrogenation) of DHPS on the cathode generates DHPS-2H (step 1), which is kinetically faster than the direct H₂O reduction, and then initiates the HER reaction while it flows through a catalyst bed in the reactor. The dehydrogenation (or oxidation) of DHPS-2H on the Pt catalyst in the gas production reactor spontaneously releases H₂ (step 2), with which DHPS is regenerated for a second round of reaction upon circulating back to the anodic compartment.

For the OER side, [Fe(CN)₆]^{3-/4-} serves as an energetic charge carrier and instigates OER reaction when it flows through the NiFe(OH)₂ catalyst bed in a separate reactor (steps 3 and 4). With such a flow cell setup, DHPS and [Fe(CN)₆]⁴⁻ are instantaneously regenerated as the electrolyte circulates through the cell while H₂ and O₂ are uninterruptedly produced in the tank, thus obviating complex gas electrode design and gas mixing. The mechanistic process underlying the DHPS-mediated HER reaction was collectively scrutinized with operando UV-vis, NMR and EPR spectroscopy and computational studies in the following examples.

### Example 2. Synthesis of DHPS

### 3,4-Diaminobenzenesulfonic acid

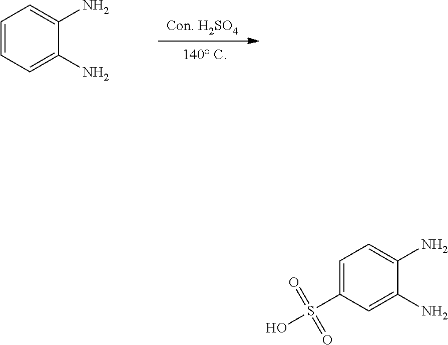 [SMILES: Nc1ccccc1N ; Nc1ccc(S(=O)(=O)O)cc1N]

In a round bottom flask, benzene-1,2-diamine (20.0 g, 185 mmol) was added portion wise to concentrated H₂SO₄ (110 mL) over a period of 30 min. The resulting turbid solution was stirred for 30 min at room temperature to obtain a limpid solution. After that, the reaction mixture was heated at 140° C. for 20 h. The reaction mixture was cooled to 0° C. and ice-cold water (ca. 200 mL) was added slowly until the product precipitated as an off-white solid. The solid was filtered by vacuum filtration and dried for 2 h. The solid was transferred to a round bottom flask and deionized (DI) water (100 mL) was added. The turbid was stirred for 60 min, filtered and dried to get 3,4-diaminobenzenesulfonic acid as an off-white solid (19.8 g, 58%).

¹H NMR (400 MHz, DMSO-d₆) δ 7.39 (1H, d, J=1.8 Hz), 7.19 (1H, dd, J₁=8.4 Hz, J₂=1.8 Hz), 6.86 (1H, d, J=8.4 Hz). (Note: the signals for the amine and sulfonic acid protons were a broad hump and merged with aromatic protons)

DHPS (Hollas, A. Et al., Nat. Energy 2018, 3, 508-514)

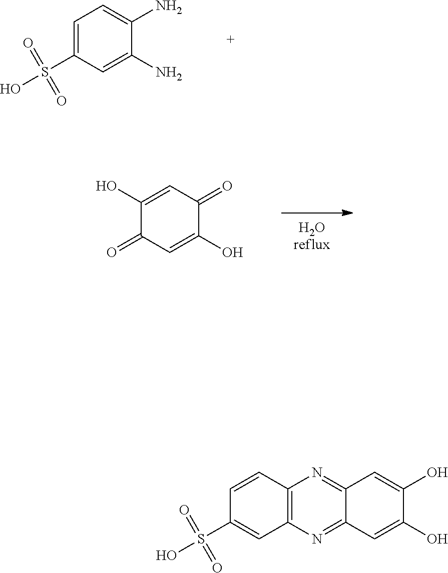 [SMILES: Nc1ccc(S(=O)(=O)O)cc1N ; O=C1C=C(O)C(=O)C=C1O ; O=S(=O)(O)c1ccc2nc3cc(O)c(O)cc3nc2c1]

In a round bottom flask, DI water (130 mL) was heated to 105° C. in an oil bath. While warming the water, 2,5-dihydroxy-1,4-benzoquinone (8.27 g, 59.0 mmol) was added portion wise and stirred for 5 min at 105° C. Then, 3,4-diaminobenzenesulfonic acid (11.1 g, 59.0 mmol) was added portion-wise over a 5 min period. The resulting dark brown reaction mixture was heated to reflux for ca. 16 h. The reaction mixture was cooled to room temperature and diluted with acetone (150 mL). The solid was filtered by vacuum filtration, washed with water (3×50 mL) and acetone (3×50 mL). The solid was dried using vacuum for two days and subsequently dried under reduced pressure using a rotary evaporator at 50° C. for 2 h to obtain DHPS as a dark gold solid (14.8 g, 86%).

¹H NMR (400 MHz, DMSO-d₆) δ: 8.30 (s 1H), 8.14 (d, J=8.2 Hz, 1H), 8.06 (d, J=8.2 Hz, 1H), 7.37 (s 1H), 7.35 (s 1H) (Note: The acidic protons (OH, SO₃H) were observed as a broad hump from (8.8-8.4). ¹³C NMR (100 MHz, DMSO-d₆) δ:157.4, 156.6, 149.4, 140.3, 138.9, 137.1, 135.1, 128.3, 126.1, 120.8, 105.3, 104.1.

### Example 3. CV Tests of Redox Mediators, DHPS and [Fe(CN)₆]^{3-/4-}

### CV Tests

The electrochemical properties of DHPS and [Fe(CN)₆]^{3-/4-} were analyzed by CV in 4.0 M of NaOH aqueous solution on an Autolab electrochemical workstation (Metrohm, PSTA30) with a three-electrode cell system. Glassy carbon, graphite rod and Hg/HgO were used as the working, counter and reference electrodes, respectively. The electrolyte was 4 M NaOH aqueous solution bubbled with N₂ for 1 h prior to use. For the CV test of DHPS, the cells were sealed and protected by N₂.

The peak currents at different scan rate follow a linear relation with the square root of the scan rate for both the oxidation and reduction reactions, indicating a diffusion-controlled and electrochemically reversible process. The diffusion coefficient could be determined with the Randles-Sevcik equation (Pan, F. et al., Chem. Mater. 2016, 28, 2052 2057) below:

Iₚ=2.69×10⁵n^{3/2}AD^{1/2}Cv^{1/2}

where Iₚ is the peak current in ampere, n is the number of electrons transferred (assumed to be two for DHPS, one for [[Fe(CN)₆]^{3-/4-}), A is the electrode area in cm², D is the diffusion coefficient in cm²/s, C is the electrolyte concentration in mol/cm³, and v is the scan rate in V/s.

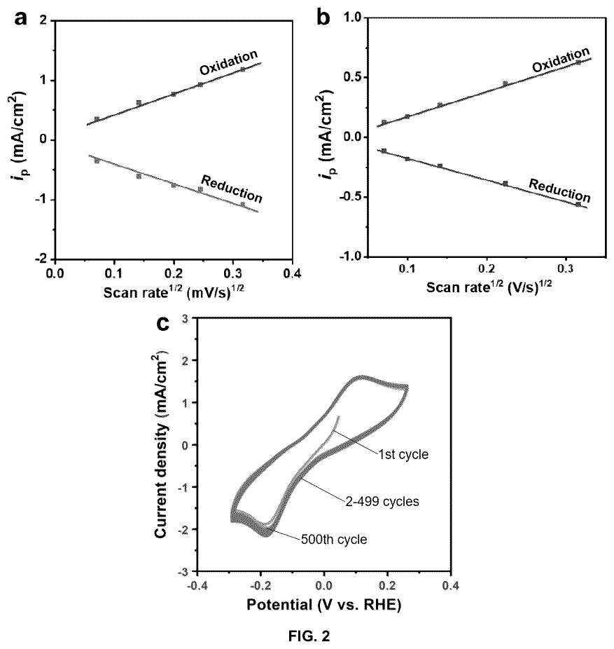

FIG. 2 shows the CV tests of DHPS and [Fe(CN)₆]^{3-/4-}. The diffusion coefficient of DHPS and [Fe(CN)₆]^{3-/4-} were calculated to be 7.5×10⁻⁷ and 2.5×10⁻⁶ cm²/s, respectively.

### Example 4. Synthesis of the Catalysts

Hierarchical Pt-decorated Ni(OH)₂ and NiFe(OH)₂ nanosheets were synthesized as the HER and OER catalyst, respectively. Considering that powdery materials are susceptible to flowing with the electrolyte, the materials were thus deposited on Ni foam substrate.

### Hierarchical Ni(OH)₂ Nanosheets Substrate

Firstly, 5 pieces of Ni foam (3×2 cm²) were immersed in 1 M HCl under ultrasonic treatment to wash away the oxidation layer on the surface. Then, the Ni substrates were rinsed with DI water and transferred to a sealed glass bottle containing HCl aqueous solution (80 mL, 0.11 mM). The reaction mixture was heated at 80° C. under stirring for 20 h. The substrates were washed with DI water and dried in a vacuum oven at 50° C.

### Electrodeposition of Pt Nanoparticle (Pt—Ni(OH)₂@Ni Foam)

The electrochemical deposition was conducted in a three-electrode electrochemical system, using 20 mL of 1 M KOH solution containing K₂PtCl₄ (200 μL, 60 mM) as the electrolyte. The Ni(OH)₂ substrate, graphite rod, and Hg/HgO electrode were used as the working, counter and reference electrodes, respectively. The electrochemical deposition was performed by CV in a potential range of from −0.9 to −1.9 V vs. Hg/HgO for 50 cycles at a sweep rate of 5 mV s⁻¹.

### Hierarchical Fe-Doped Ni(OH)₂ Nanosheets

Porous and nanocrystalline flakes of NiFe(OH)₂ was synthesized on Ni foam through a facile self-regulated acid-etching method (Wu, H. et al., J. Mater. Chem. A 2017, 5, 24153-24158). For NiFe(OH)₂ growth, a piece of HCl-treated Ni foam was treated for the preparation of Ni(OH)₂ nanosheets. Then, the Ni foam was transferred to a sealed glass bottle filled with 20 mL of 0.1 mM HCl and 0.01 mM Fe(NO₃)₃·9H₂O, under stirring and heated at 80° C. for 20 h.

### Example 5. Characterization of the Catalysts

The two catalysts, Pt-decorated Ni(OH)₂ and NiFe(OH)₂ nanosheets, prepared in Example 4 were taken for characterization studies.

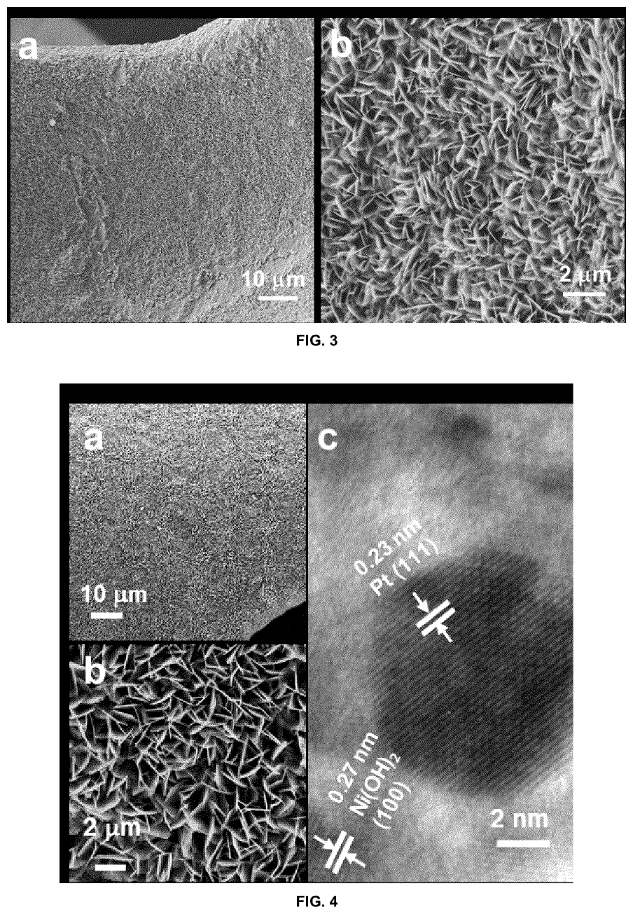

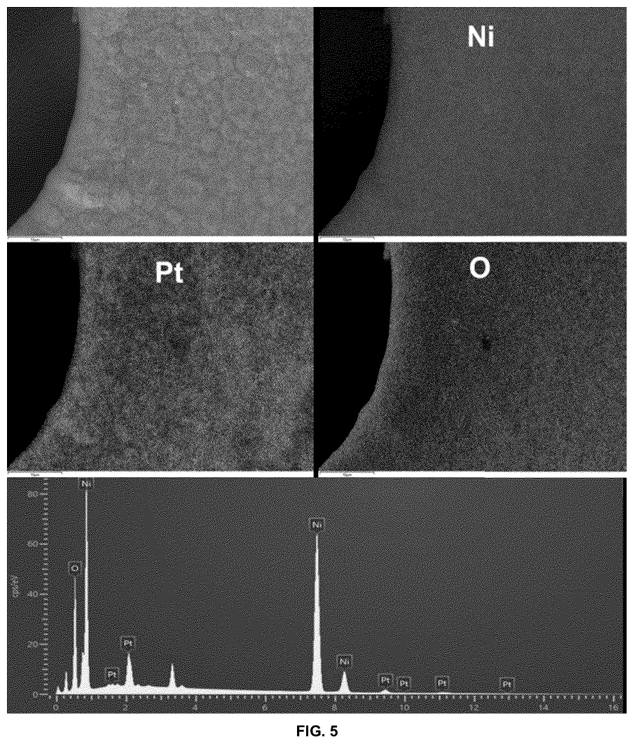

For the synthesis of Pt—Ni(OH)₂, a uniform network composed of interwoven ultrathin Ni(OH)₂ nanosheets (FIG. 3) was firstly grown on Ni foam substrate through an in-situ acid-etching method. Pt nanoparticles of ˜6 nm in diameter were then uniformly deposited on Ni(OH)₂ via a potential scan method (FIG. 4). The nanosheet structure is advantageous to electrolyte permeation and release of formed H₂ gas for catalytic HER reaction. TEM image shows that the nanoparticles had a lattice spacing of ˜0.23 nm which is consistent with the (111) plane of metallic Pt. The surrounding substrate had a lattice spacing of ˜0.27 nm which is consistent with the (110) plane of Ni(OH)₂. EDX mapping analysis also confirmed the homogeneous dispersion of Pt (FIG. 5).

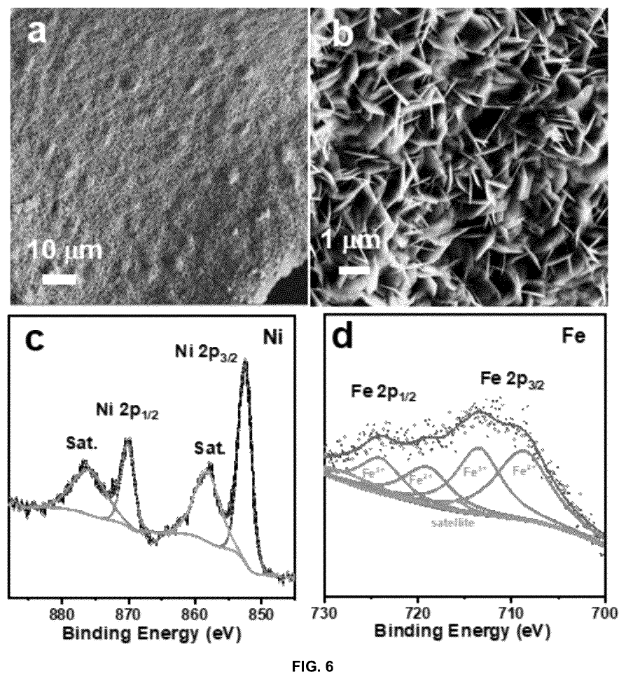

In comparison, porous and nanocrystalline flakes of NiFe(OH)₂ were synthesized on Ni foam through a facile self-regulated acid-etching method (Wu, H. et al., J. Mater. Chem. A 2017, 5, 24153-24158). SEM images (FIG. 6a,b) show similar interwoven ultrathin nanosheets grown on Ni foam network. The composition and element chemical state of NiFe(OH)₂ were confirmed by XPS. The Ni spectrum (FIG. 6c) consists of two main peaks with binding energies at 852.6 (Ni 2p3/2) and 870.2 eV (Ni 2p1/2), with a spin-energy separation of 17.6 eV, which is characteristic for Ni(OH)₂ phase and in good agreement with previous reports (Mao, L. et al., Electrochim. Acta 2016, 196, 653-660; and Hadden, J. H. L., Ryan, M. P. & Riley, D. J., ACS Appl. Energy Mater. 2020, 3, 2803-2810). The peaks at 876.9 and 858.3 eV around Ni 2p1/2 and Ni 2p3/2 signals were marked as the satellite peaks. The Fe spectrum (FIG. 6d) exhibits two sets of typical 2p peaks of Fe²⁺ (708.7 and 719.2 eV) and Fe³⁺ (713.5 and 724.0 eV) ions, which verifies the presence of Fe (Wu, H. et al., J. Mater. Chem. A 2017, 5, 24153-24158).

### Example 6. Electrochemical-Chemical Characterizations

The electrochemical-chemical properties of the materials prepared in Examples 2 and 4 were studied. CV tests were carried out by following the protocol in Example 3.

### LSV Tests

LSV was conducted on an Autolab electrochemical workstation (Metrohm, PSTA30). Potentials were presented versus reversible hydrogen electrode (RHE) based on the following equation:

E(V vs. RHE)=E_{Hg/HgO}+0.098 V+0.0591 V×pH

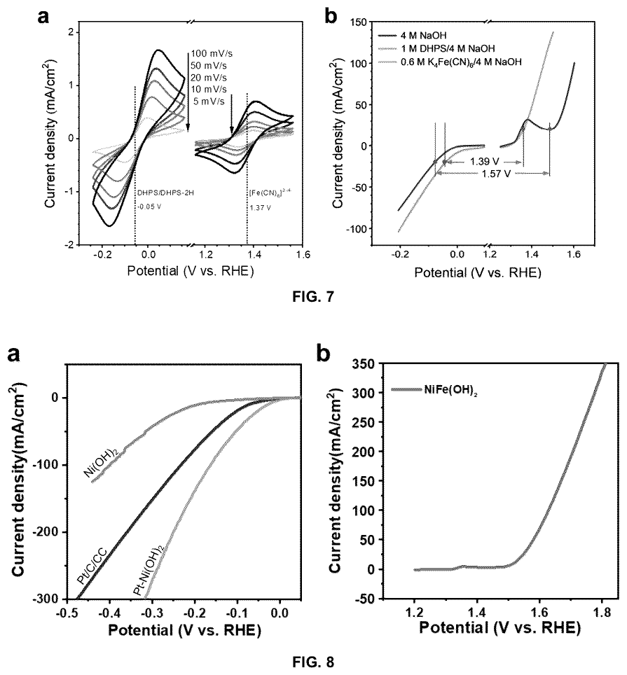

The electrochemical properties of DHPS and [Fe(CN)₆]^{3-/4-} were scrutinized with voltammetric measurements. DHPS exhibited exemplary robustness in alkaline solution at a potential of −0.05 V (vs. RHE) which nearly coincides with that of HER, while [Fe(CN)₆]^{3-/4-} had a potential of 1.37 V (vs. RHE) which is slightly higher than that of OER reaction (FIG. 7a).

One essential prerequisite for the decoupled water splitting based on a regenerative electrochemical-chemical cycle is that the electrochemical process of the pair of redox mediators should inherently be faster than that of the electrolytic HER and OER reactions. This is so that the overall kinetics, particularly here, that are in tandem with additional HER and OER catalytic chemical process will not be impaired. A controlled LSV was thus conducted to compare the reaction kinetics of both OER and HER reactions with those of the above two redox mediators, DHPS and [Fe(CN)₆]^{3-/4-} (FIG. 7b). With the same set of catalysts, direct overall electrolytic water splitting in alkaline solution required 1.57 V at a current of 20 mA/cm², considerably higher than the thermodynamic limit, 1.23 V. In contrast, only 1.39 V was required to complete the redox reactions of DHPS and [Fe(CN)₆]⁴⁻ at the same current. The first oxidation peak at ˜1.38 V (vs. RHE) was due to the oxidation of Ni²⁺ to Ni³⁺ in NiFe(OH)₂.

### Example 7. Catalytic Properties of the Pt—Ni(OH)₂ and NiFe(OH)₂

The catalytic properties of Pt—Ni(OH)₂ and NiFe(OH)₂ towards HER and OER reactions were examined by LSV and CV measurements in 4 M NaOH electrolyte by following the protocols in Examples 3 and 6, respectively.

### Results and Discussion

The reductive sweep curve of the Pt—Ni(OH)₂ catalyst exhibited an onset overpotential of ˜10 mV vs. RHE, followed by a sharp current enhancement corresponding to H₂ evolution, which is far superior to the Ni(OH)₂ electrode and 10% commercial Pt/C—CC electrode (FIG. 8a). The OER performance was evaluated with NiFe(OH)₂, which exhibited a distinct Ni^{II/III} redox transition at ˜1.39 V vs. RHE, and a prominent OER activity with an onset potential of ˜1.47 V vs. RHE (FIG. 8b).

### Example 8. Spatially Decoupled Water Splitting

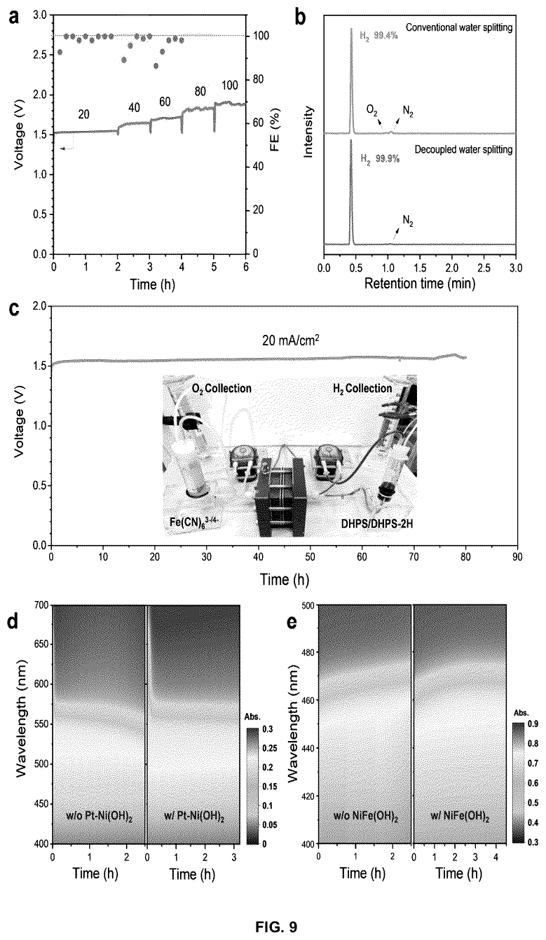

Based on the above examples, an electrolytic flow cell integrated with two catalyst packed-bed reactors (see FIG. 9) was assembled according to Example 1, to demonstrate continuous off-electrode productions of H₂ and O₂.

### Electrolytic Flow Cell Test

An anion-exchange membrane (Sustain-ion® X37-50 membrane) was employed to separate the two electrode compartments, through which OH⁻ migrates from the cathodic to anodic side during the electrolytic process. Aqueous solutions of 10 mL of 0.6 M DHPS in 4 M NaOH and 50 mL of 0.6 M K₃Fe(CN)₆ in 4 M NaOH were respectively used as the catholyte and anolyte circulating between the corresponding electrode compartment and reactor. Here, the anolyte was in excess to ensure that the HER reaction is not limited by the more sluggish OER reaction, and thus the following discussion would be based on the cathodic reaction unless otherwise stated.

### Electrolytic Flow Cell Test and Hydrogen Evolution Reaction

The cell was assembled by sandwiching two pieces of carbon felt as cathode and anode. The active area of the electrode was 5 cm². Each half-cell had a graphite plate as the current collector connected to the external electrical circuit. An anion-exchange membrane (Sustainion® X37-50 membrane) was used as the separator. The anolyte consisted of 50 mL of 0.6 M K₃Fe(CN)₆ in 4 M NaOH, while the catholyte consisted of 12 mL of 0.6 M DHPS in 4 M NaOH. The electrolytes were circulated through the cell stack and tanks using peristaltic pumps. The Pt—Ni(OH)₂ catalyst was loaded in the cathodic tank, while the NiFe(OH)₂ catalyst was loaded in the anodic tank. 10 cm² Pt—Ni(OH)₂ catalyst and 15 cm² NiFe(OH)₂ catalyst were used in the test (FIG. 9a,c). The voltage profiles of the flow cell were recorded in galvanostatic mode with an Arbin battery tester. The catholyte was purged with N₂ before charging. Gases produced in the tank were collected by water displacement. A measuring cylinder filled with water was placed upside-down in a water bath. The gas produced in the tank was fed into the water-filled measuring cylinder through a silicone tube. The gas production was then determined by the volume of displaced water.

### Hydrogen and Oxygen Production During Decoupled Water Splitting

An anion-exchange membrane (Fumasep® FAAM-15) was used as the separator. The anolyte consisted of 25 mL of 0.4 M K₄Fe(CN)₆ and 0.2 M K₃Fe(CN)₆ in 4 M NaOH while 25 mL of 0.2 M DHPS in 4 M NaOH was used as the catholyte. The electrolytes were circulated through the cell stack and tanks using peristaltic pumps. 5 pieces of Pt—Ni(OH)₂ catalyst (1×1 cm²) and 5 pieces of NiFe(OH)₂ catalyst (1×1 cm²) were added in the cathodic tank and anodic tank, respectively. The current density was 10 mA/cm². Gases produced in the tank were collected by water displacement method. Two measuring cylinders were filled with water and placed upside-down in a water bath. The gas produced in the tank was fed into the water-filled measuring cylinder through a silicone tube. The gas production was determined by the volume of displaced water in the measuring cylinder.

### Galvanostatic Intermittent Titration Technique (GITT) of Redox Flow Battery

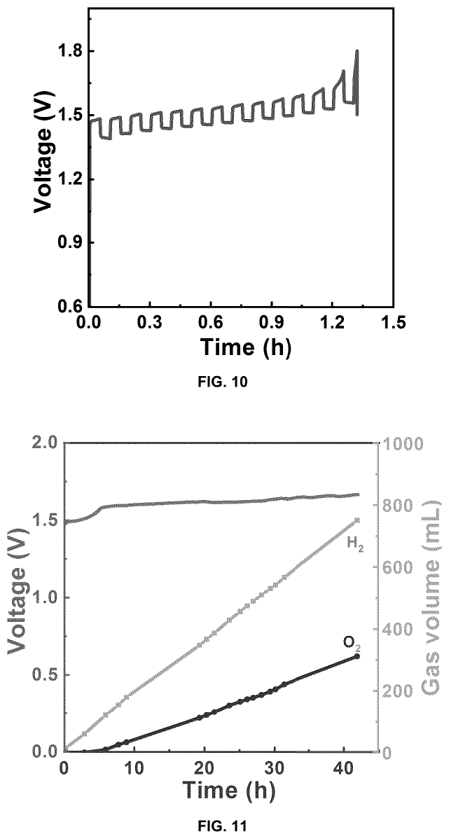

The electrolytic flow cell was further studied by GITT, for which a current density of 40 mA/cm² was repeatedly applied for 3 min, followed by 3 min relaxation (FIG. 10). This cell was assembled as the normal redox-flow battery without catalyst in the tanks. An anion-exchange membrane (Sustainion® X37-50 membrane) was used as the separator. The anolyte consisted of 12 mL of 0.4 M K₄Fe(CN)₆ and 0.2 M K₃Fe(CN)₆ in 4 M NaOH, and the catholyte consisted of 12 mL of 0.2 M DHPS in 4 M NaOH. The electrolytes were circulated through the cell stack and tanks using peristaltic pumps.

### Gas Chromatography (GC) Headspace Measurement

GC headspace analysis was performed using a Shimadzu GC-2010 Plus system by direct auto-injection of gas from the headspace of the catholyte connected to the GC through a silicone tube. For the decoupled water splitting system, the flow battery and electrolyte were prepared as described in the protocol above. For the conventional water splitting system, the cell was assembled by sandwiching NiFe(OH)₂ and Pt—Ni(OH)₂ as the anode and cathode, respectively. 50 mL of 4 M NaOH and 12 mL of 4 M NaOH were used as anolyte and catholyte, respectively. Each catholyte was purged with N₂ before charging. The electrolysis process was operated at a constant current of 40 mA/cm².

### Results and Discussion

FIG. 9a depicts the voltage profile of the flow cell at different current densities from 20 to 100 mA/cm². In the initial short period of electrolysis, the cell voltage went up quickly with the reduction of DHPS on the electrode (reaction 1). The formed DHPS-2H was then dehydrogenated, which releases H₂ in the reactor, while the catholyte flowed through the Pt—Ni(OH)₂ catalyst bed. When the rate of catalytic DHPS-2H dehydrogenation in the reactor is equal to the reduction rate of DHPS on the electrode, the cell voltage becomes stabilized and H₂ is constantly generated in the hydrogen production reactor.

Similar electrochemical-chemical processes of [Fe(CN)₆]^{3-/4-} took place at the anodic side involving constant O₂ evolution on NiFe(OH)₂ catalyst bed. A voltage plateau at 1.53 V and a faradaic efficiency of nearly 100% were attained at 20 mA/cm² after the cell reached steady state. Such a high faradaic efficiency was well retained for prolonged test as revealed in FIG. 11. The plateau voltage increases with current density as a higher concentration of DHPS-2H is required for enhanced H₂ production in the reactor besides other overpotentials. Upon increasing the current density, the average cell voltage increased to 1.64 V at 40 mA/cm², 1.70 V at 60 mA/cm², 1.83 V at 80 mA/cm² and 1.91 V at 100 mA/cm². For each increment of current density, the faradaic efficiency of the cell initially attenuated and then gradually ramped up before a new steady state was established (FIG. 9a). This is due to the fact that despite the instantaneous increase of DHPS reduction on the electrode, it takes a short while to generate sufficient DHPS-2H in the electrolyte before the H₂ production rate in the reactor catches up and becomes balanced.

The electrolytic flow cell was further studied by GITT, which determined the IR drop accounts for around 19 mV of the voltage increase for every 10 mA/cm² of current density increment (FIG. 10). The produced H₂ gas was analyzed by GC and nearly no O₂ was detected as compared to that collected from the conventional electrolyzer (FIG. 9b), showing the superiority of the electrolytic flow cell in producing pure H₂. The stability of the decoupled water electrolyzer system was assessed at a constant current density of 20 mA/cm², and the cell voltage retained at around 1.53 V for more than 80 h without obvious degradation (FIG. 9c).

### Comparative Example 1. Comparison of Decoupled and Direct Water Splitting

The voltage profile of direct water splitting was evaluated by following the same setup and protocol for decoupled water splitting described in Example 8. The electrolyte used was 50 mL of 4 M NaOH. The overall energy efficiency was calculated as

$$( ξ = \frac{1.23 V}{{E}_{cell voltage}} \times 100 \% )$$

where 1.23 V corresponds to the theoretical water splitting voltage.

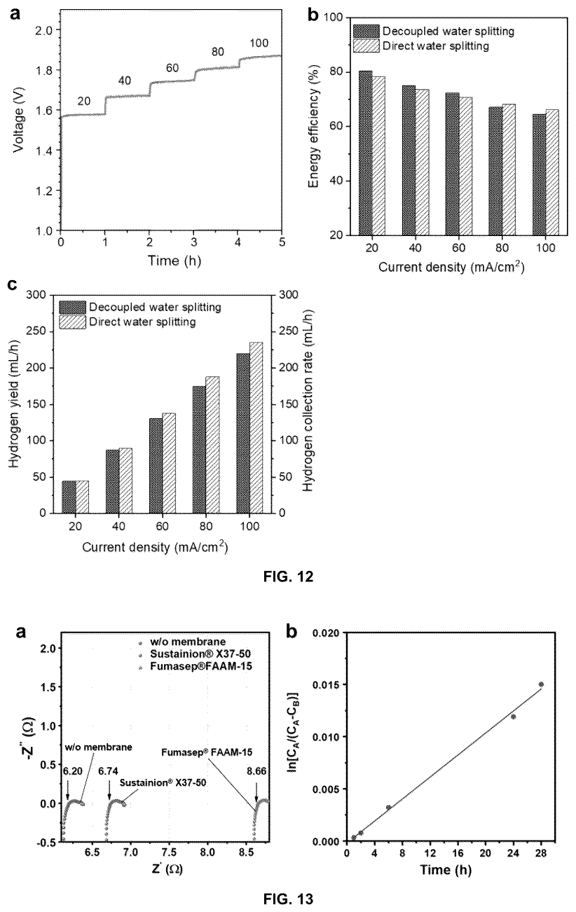

The voltage profile of direct water splitting is shown in FIG. 12a. The overall energy efficiency, H₂ yield and collection rate of decoupled and direct water splitting are shown in FIG. 12b-c. The overall energy efficiency of decoupled water splitting was higher than direct water splitting at 20, 40 and 60 mA/cm². H₂ yield and collection rate of decoupled water splitting were a slightly lower than direct water splitting at relatively high current due to the fact that it needs time to generate sufficient DHPS-2H in the electrolyte before the H₂ production rate in the reactor catches up and becomes balanced initially. At a longer duration (when the amount of charge is sufficiently more than the amount of DHPS in the reaction), the two methods should present rather identical H₂ production yield.

### Comparative Example 2. Comparison of Different Decoupled Water Splitting Methods

The overall energy efficiency of the spatially decoupled water electrolyzer reported here, and other previously reported decoupled water splitting systems was calculated by using the overall energy efficiency equation in Comparative Example 1.

### Results and Discussion

TABLE 1
Comparison of the spatially decoupled water electrolyzer reported here with other
decoupled water splitting systems reported in literature.

| Redox mediators | Catalyst | Electrolyte | Total voltage for water splitting | $\begin{matrix}Energy \\ Efficient \\ ( ξ = \frac{1.23 V}{{E}_{cell voltage}} \times 100 \% )\end{matrix}$ | Reference |
|---|---|---|---|---|---|
| Fe(CN)₆^{4-/3-}/ | Pt/Ni(OH)₂ for | 4M NaOH | 1.53, 1.70, and 1.91 V | 80.4, 72.4, and 64.4 | This work |
| DHPS | HER | | (20, 60, and 100 mA/cm²) | (20, 60, and | |
| | NiFe(OH)₂ for | | | 100 mA/cm²) | |
| | OER | | | | |
| H₃PMo₁₂O₄₀ | Pt for HER | 1M | 2.94 V (100 mA/cm²) | 41.8 | Symes, M. |
| | and OER | H₃PO₄ | | | D. & |
| | | | | | Cronin, L., |
| | | | | | Nat. Chem. |
| | | | | | 2013, 5, |
| | | | | | 403-409 |
| H₄[SiW₁₂O₄₀] | Pt for HER | 1M | 2.21 V (50 mA/cm²) | 55.7 | Rausch, B. |
| | and OER | H₃PO₄ | | | et al., |
| | | | | | Science |
| | | | | | 2014, 345, |
| | | | | | 1326-1330 |
| V(II)/V(III) | Mo₂C for HER | 1M | 2.5 V (60 mA/cm²) | 49.2 | Amstutz, V. |
| Ce(III)/Ce(IV) | RuO₂ for OER | H₂SO₄ | | | et al., |
| | | | | | Energy |
| | | | | | Environ. |
| | | | | | Sci. 2014, |
| | | | | | 7, 2350- |
| | | | | | 2358 |
| FcNCl | Ni₂P/Ni for | 0.5M | 2.43 V (10 mA/cm²) | 50.6 | Li, W. et al., |
| | HER | Na₂SO₄ | | | Chem |
| | Ni for OER | | | | 2018, 4, |
| | | | | | 637-649 |
| NiOOH/Ni(OH)₂ | RuO₂/IrO₂-Ti- | 1M NaOH | 1.98 V (10 mA/cm²) | 62.1 | Chen, L. et |
| | mesh for OER | | | | al., Nat. |
| | and Pt-Ti- | | | | Commun. |
| | mesh for HER | | | | 2016, 7, |
| | | | | | 11741 |
| NiOOH/Ni(OH)₂ | Ni_{0.9}Co_{0.1}(OH)₂ | 0.6M | 1.44, 1.50, 1.56 and 1.60 V | 85.4, 82.0, 78.7 and | Dotan, H. |
| (25 and 95° C.) | for OER and | K₂CO₃ | (10, 50, 100 and 200 mA/cm²) | 76.8% (10, 50, 100 | et al., Nat. |
| | Ni for HER | and 0.4M | | and 200 mA/cm²) | Energy |
| | | KHCO₃ | | | 2019, 4, |
| | | | | | 786-795 |

### Comparative Example 3. Comparison of Two Different Anion-Exchange Membranes

### Ion Permselectivity Tests

A H-cell setup, in which two cell compartments were separated by an anion-exchange membrane, was used to assess and compare the ion permselectivity of Sustainion® X37-50 and Fumasep® FAAM-15 membranes. The concentration of DHPS in the deficiency cell was monitored by UV-vis measurement after different durations.

As shown in FIG. 13a, the resistance of Sustainion® X37-50 membrane was only 1.08 Ω·cm² while the resistance of Fumasep® FAAM-15 membrane was 4.92 Ω·cm². However, the ion permselectivity of DHPS molecule through Fumasep® FAAM-15 membrane was much better than Sustainion® X37-5 membrane. No DHPS was detected in the deficiency cell even after 24 h when Fumasep® FAAM-15 membrane was used. In comparison, the Sustainion® X37-5 membrane presented relatively large crossover (FIG. 13b). However, the crossover of DHPS should not present a big concern, considering the oxidized DHPS molecule does not have further reaction in the anolyte in the electrolytic flow cell.

### Example 9. HER/OER Reactions of the Mediators on the Respective Catalyst Tanks in Redox-Flow Cell

To monitor the HER/OER reactions of the mediators on the respective catalyst tanks in redox-flow cell, operando UV-vis spectroscopic measurement was conducted.

### Operando UV-Vis Spectroscopic Measurement

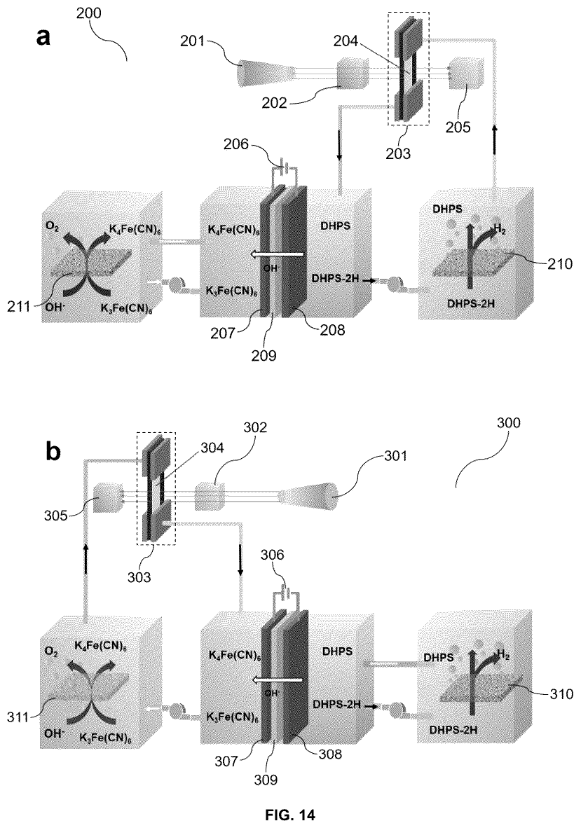

UV-vis spectra of the electrolytes from an operational electrolytic flow cell were collected with a SHIMADZU UV-1800 spectrometer. The setup is shown in FIG. 14. A custom-designed spectroelectrochemical cell with 10 μm optical path length was connected to the anodic or cathodic flow channel outlet of the flow cell. 4 M NaOH solution was used as the blank. When collecting the operando UV-vis spectroscopic measurements of the catholyte, a anolyte consisting of 50 mL of 0.2 M K₃Fe(CN)₆ and 0.4 M K₄Fe(CN)₆ in 4 M NaOH, and a catholyte consisting of 12 mL of 0.2 M DHPS in 4 M NaOH were used. 5 pieces of Pt—Ni(OH)₂ catalyst (1×1 cm²) were settled in the catholyte tank. When collecting the operando UV-vis spectroscopic measurements of the anolyte, a anolyte consisting of 12 mL of 0.2 M K₃Fe(CN)₆ and 0.4 M K₄Fe(CN)₆ in 4 M NaOH, and a catholyte consisting of 25 mL of 0.2 M DHPS in 4 M NaOH were used. 5 pieces of NiFe(OH)₂ catalyst (1×1 cm²) were settled in the tank. The cell was charged at 10 mA/cm².

### Results and Discussion

A spectroelectrochemical flow cell (FIG. 14) was connected to the outlet cathodic or anodic flow channel of a flow cell to track the concentration changes of DHPS or [Fe(CN)₆]³⁻ in the respective electrolyte upon electrolysis. FIG. 14a depicts the spectroelectrochemical flow cell for operando UV-vis spectroscopic measurements of the catholyte. As shown, there is a spectroelectrochemical flow cell 200 that includes a light source 201, a monochromator 202, a polyethylene terephthalate (PET) gasket 203 comprising a 10 μm optical path length 204, a detector 205, a power supply 206, an anode 207, a cathode 208, a membrane 209, and catalysts 210 and 211. FIG. 14b depicts the spectroelectrochemical flow cell for operando UV-vis spectroscopic measurements of the anolyte. As shown, there is a spectroelectrochemical flow cell 300 that includes a light source 301, a monochromator 302, a PET gasket 303 comprising a 10 μm optical path length 304, a detector 305, a power supply 306, an anode 307, a cathode 308, a membrane 309, and catalysts 310 and 311.

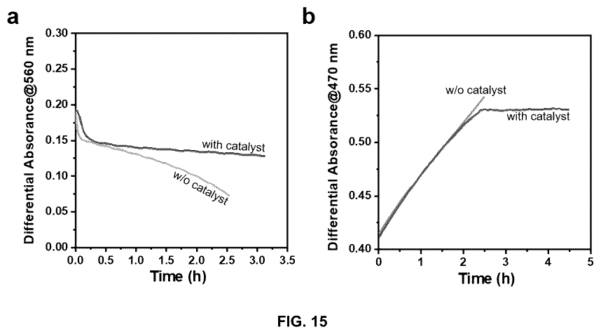

In the absence of catalyst, the concentration of DHPS monotonously decreased over the charging process (FIG. 9d and FIG. 15a). In comparison, the cell loaded with Pt—Ni(OH)₂ showed extended time series spectra of DHPS with its concentration nearly stabilized while the reactions proceeded, implying the balance of consumption and generation of DHPS on the electrode and in the reactor. Similarly, the concentration of [Fe(CN)₆]³⁻ in the anolyte increased constantly without loading NiFe(OH)₂, which however reached a steady state in the presence of catalyst (FIG. 9e and FIG. 15b), suggesting a balanced electrochemical-chemical reaction cycle upon redox-mediated OER in the anodic compartment.

1. A spatially decoupled redox flow water electrolyzer, comprising:
a hydrogen-producing catholyte section comprising a catholyte tank, having a cathode, and a hydrogen generation compartment, where the catholyte tank and the hydrogen generation compartment are fluidly connected to one another by a fluid pathway, so as to facilitate the circulation of a liquid catholyte from the catholyte tank to the hydrogen generation compartment and back to the catholyte tank;
an oxygen-producing anolyte section comprising an anolyte tank, having an anode, and an oxygen producing compartment, where the anolyte tank and the oxygen producing compartment are fluidly connected to one another by a fluid pathway, so as to facilitate the circulation of a liquid anolyte from the anolyte tank to the oxygen producing compartment and back to the anolyte tank;
an anion-exchange membrane disposed between the catholyte and anolyte tanks that allows anions to move from the catholyte tank to the anolyte tank; and
a current collector attached to the catholyte and anolyte tanks, wherein:
the hydrogen generation compartment is configured to house a catalyst capable of catalysing hydrogen production when brought into contact with a cathodic redox mediator when the cathodic redox mediator is in a reduced state; and
the oxygen generation compartment is configured to house a catalyst capable of catalysing oxygen production when brought into contact with an anodic redox mediator when the anodic redox mediator is in an oxidised state.

2. The electrolyzer according to claim 1, wherein:
(a) the hydrogen-producing catholyte section further comprises:
a liquid catholyte that comprises a supporting electrolyte and a cathodic redox mediator capable of producing hydrogen; and
a catalyst capable of catalysing hydrogen production when brought into contact with a cathodic redox mediator when the cathodic redox mediator is in a reduced state, where the catalyst is housed in the hydrogen generation compartment; and
(b) the oxygen-producing anolyte section further comprises:
a liquid anolyte that comprises a supporting electrolyte and an anodic redox mediator capable of producing oxygen; and
a catalyst capable of catalysing oxygen production when brought into contact with an anodic redox mediator when the anodic redox mediator is in an oxidised state, where the catalyst is housed in the oxygen generation compartment.

3. The electrolyzer according to claim 2, wherein the supporting electrolyte comprises a solvent and one or more compounds or salts that provide ions.

4. The electrolyzer according to claim 3, wherein the ions in the salts that provide ions are selected from:
hydroxide ions and/or chloride ions; and
one or more of the groups consisting of ammonium ions, lithium ions, sodium ions, potassium ions, magnesium ions, calcium ions.

5. The electrolyzer according to claim 3, wherein the solvent is water.

6. The electrolyzer according to claim 3, wherein one or more of the following apply:
(a) the pH of the electrolyte is from 11 to 15;
(b) the concentration of the one or more compounds or salts that provide ions in the solvent is from 0.05 to 10 M.

7. The electrolyzer according to claim 2, wherein the cathodic redox mediator is selected from one or more of DHPS/DHPS-2H, iron (III) triethanolamine/iron (II) triethanolamine, phenazine and derivatives thereof, and viologen and derivatives thereof.

8. The electrolyzer according to claim 2, wherein the cathodic redox mediator is provided in the liquid catholyte at a total concentration of the redox mediator(s) from 0.05 to 3 M.

9. The electrolyzer according to claim 2, wherein the anodic redox mediator is selected from one or more of [Fe(CN)₆]³⁻/[Fe(CN₆)]⁴⁻, [MnO₄]²⁻/[MnO₄]⁻, ferrocene and derivatives thereof, and TEMPO and derivatives thereof.

10. The electrolyzer according to claim 2, wherein the anodic redox mediator is provided in the liquid anolyte at a total concentration of the redox mediator(s) from 0.05 to 3 M.

11. The electrolyzer according to claim 2, wherein the catalyst in the oxygen generation compartment is selected from one or more of the group consisting of NiFe(OH)₂@Ni, IrO₂, RuO₂, other transition metal oxides (TMOs), carbides (TMCs), nitrides (TMNs), phosphides (TMPs), dichalcogenides (TMDs), and borides (TMBs).

12. The electrolyzer according to claim 2, wherein the catalyst in the hydrogen generation compartment is selected from one or more of the group consisting of Pt—Ni(OH)₂@Ni, Pt@C, a transition metal (TM), a metal alloy, a transition metal oxide (TMO), a transition metal carbide (TMCs), a transition metal nitride (TMNs), a transition metal phosphide (TMPs), a transition metal dichalcogenide (TMD), a transition metal boride (TMBs), and a noble metal.

13. The electrolyzer according to claim 2, wherein the electrolyzer is configured to introduce the liquid catholyte and/or the liquid catholyte to the hydrogen generation compartment and oxygen generation compartment, respectively, as a spray.

14. The electrolyzer according to claim 2, wherein the electrolyzer is able to generate oxygen and/or hydrogen with a purity of greater than or equal to 99.9%.

15. The electrolyzer according to claim 2, wherein the weight ratio of the catalyst in the oxygen generation compartment to the catalyst in the hydrogen generation compartment is from 0.1:1 to 10:1.

16. A method of using a spatially decoupled redox flow water electrolyzer according to claim 1, involving the steps of:
(a) supplying:
(i) a liquid catholyte that comprises a supporting electrolyte and a cathodic redox mediator capable of producing hydrogen; and
a catalyst capable of catalysing hydrogen production when brought into contact with a cathodic redox mediator when the cathodic redox mediator is in a reduced state, where the catalyst is housed in the hydrogen generation compartment; and
(ii) a liquid anolyte that comprises a supporting electrolyte and an anodic redox mediator capable of producing oxygen; and
a catalyst capable of catalysing oxygen production when brought into contact with an anodic redox mediator when the anodic redox mediator is in an oxidised state, where the catalyst is housed in the oxygen generation compartment; and
(b) attaching the anode and cathode to of the anolyte and catholyte tanks, respectively, to a power supply and operating the electrolyzer for a period of time to continually produce oxygen in the oxygen producing compartment and hydrogen in the hydrogen generation compartment.

17. The method according to claim 16, wherein the supporting electrolyte comprises a solvent and one or more compounds or salts that provide ions.

18. The method according to claim 17,
wherein the ions in the salts that provide ions are selected from:
one or both of hydroxide ions and chloride ions; and
one or more of the groups consisting of ammonium ions, lithium ions, sodium ions, potassium ions, and magnesium ions, calcium ions.

19. The method according to claim 17, wherein the solvent is water.

20. The method according to claim 16, wherein one or more of the following apply:
(a) the pH of the electrolyte is from 11 to 15;
(b) the concentration of the one or more compounds or salts that provide ions in the solvent is from 0.05 to 10 M.

21.-30. (canceled)
